(19) United States
(12) Patent Application Publication
(10) Pub. No.: US 2020/0285210 A1
(43) Pub. Date: Sep. 10, 2020

(54) CONCURRENT 3-WAY BIDIRECTIONAL MESSAGE REDIRECTION

(71) Applicant: Honeywell International Inc., Morris Plains, NJ (US)

(72) Inventors: Bhavesh Gupta, Bangalore (IN); Ganesh Patil, Morris Plains, NJ (US); Jegathesan Shennakesavan, Bangalore (IN); Vinod Kumar Raavula, Morris Plains, NJ (US); Shirish Kulkarni, Morris Plains, NJ (US); Haresh Chouksey, Groton, CT (US); Prabhat Ranjan, Bangalore (IN); Ripunjeet Dutta, Bangalore (IN); Premkumar G, Morris Plains, NJ (US)

(73) Assignee: Honeywell International Inc., Morris Plains, NJ (US)

(21) Appl. No.: 16/812,296

(22) Filed: Mar. 7, 2020

Related U.S. Application Data
(60) Provisional application No. 62/815,522, filed on Mar. 8, 2019.

(51) Int. Cl. G05B 19/042; G06F 16/21; G06F 1/14

(52) U.S. Cl. CPC G05B 19/0421; G05B 2219/23027; G06F 1/14; G06F 16/21

(57) ABSTRACT

The disclosure relates to a concurrent 3-Way bidirectional message redirection component of control system which includes two coordinating supervisors each configured to process data streams representing sensor values and local inputs from an environment and to return additional data as well as operating instructions to the source of the data stream. The message redirection component determines which coordinating supervisor is currently in control of the operation of the system and moderates transitions between configurations of the system.

This application claims the benefit of priority under 35 U.S.C. § 119 to U.S. Provisional Application Ser. No. 62/815,522, filed Mar. 8, 2019. U.S. Provisional Application Ser. No. 62/815,522, filed Mar. 8, 2019, is hereby incorporated by reference.

### BACKGROUND

In a control system containing, for example, one or more headend edge routers that convey information regarding system status such as local or global sensor values and local inputs to a primary coordinating supervisor and that receive information regarding, for example, a master system clock time, resource availability, and system level commands, it may be desirable to provide a secondary coordinating supervisor that is designed to provide backup functionality for the primary coordinating supervisor as well as to provide a smooth transition to a newer secondary supervisor when a software or firmware upgrade becomes available.

Thus, there appears a need for two coordinating supervisor applications to coexist in the same network while avoiding conflicts that might arise with regard to communications addresses and/or determining which coordinating supervisor's commands are to be implemented should the two supervisors disagree as to the desired action(s). In such a system, all supervisor applications, devices, and routers need to have the capability to report to and to take commands from a single supervisor through a single IP endpoint. The addition of a second supervisor creates a potential for race conditions, i.e., for the system behavior to depend on the sequence or timing of events such that more than one behavior is possible under nominally similar operating conditions. There is a need to provide 3-way bidirectional message traffic management within the system without modification of the existing devices and edge routers while allowing two different supervisor applications to be active to at least some degree within the network at the same time.

### SUMMARY

The present system relates to a control system comprising a first coordinating supervisor configured to execute conventional database management, data storage and retrieval functions, and to issue user commands; a second coordinating supervisor configured to execute conventional database management functions, data storage and retrieval functions, and to issue system and system user commands; at least one edge router configured to collect, consolidate, format and transmit data from multiple sensors, devices, located within one or more environments under control of the control system and configured to receive and distribute data as well as system and user commands to devices within the one or more controlled environments; wherein the first coordinating supervisor includes a data redirection module configured to (a) receive consolidated data streams from the at least one edge router connected to a first port of the data redirection module, and (b) replicate the consolidated data streams for distribution along a first data path to be processed by the first coordinating supervisor and for distribution along a second data path to a second coordinating supervisor; wherein the control system has a first configuration in which the first coordinating supervisor processes a consolidated data stream of the first data path from the at least one edge router according to a first set of operating rules, combines resulting instructions with data relating to a state of the system as a whole and an inhibitory command that prevents the second coordinating supervisor from transmitting for a predetermined time period and sends combined instructions, data, and command to the first port of the control system which forwards the combined instructions, data, and command to the first port for transmission to the at least one edge router and thence to the one or more environments and to a second port attached to the second supervisor to be monitored, wherein the control system has a second configuration in which the first coordinating supervisor does not issue the inhibitory command and, following the predetermined time period, the second coordinating supervisor processes the consolidated data stream of the second data path from the at least one edge router according to a second set of operating rules, combines resulting instructions with data relating to the state of the system as a whole and sends the combined instructions and data to the first port, to edge router, and to the one or more environments.

### BRIEF DESCRIPTION OF THE DRAWING

FIG. 1 is a highly schematic representation of functional elements and the connections among those elements in a communication module located within a supervising element of a facility management system.

### DESCRIPTION

The following description should be read with reference to the drawings wherein like reference numerals indicate like elements throughout the several views. The drawings, which are not necessarily to scale, are not intended to limit the scope of the present system. The detailed description and drawings illustrate exemplary aspects of the system and are not necessarily intended to represent distinct forms of the system. Instead, the drawings are intended to improve understanding of features of the system. That a feature is present in some figures and absent from other figures is not to be interpreted as suggesting that features that appear together in some figure will always be present together or to suggest that features that do not appear together are to be viewed as mutually exclusive.

All numbers are herein assumed to be modified by the term “about.” The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

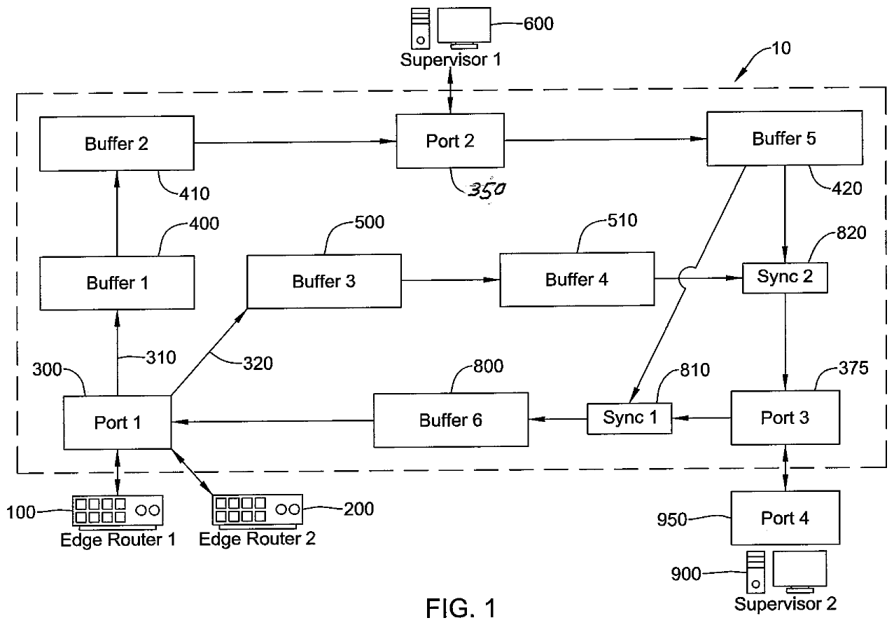

A schematic FIG. 1 illustrates a system in which a first coordinating supervisor, Supervisor 1 (600), implements an internal message redirection module (10), indicated by the broken line box, to address potential conflicts and a Supervisor 2 (900), a newly installed coordinating supervisor that may eventually replace Supervisor 1 (600) once proper operation of the system as it would be managed by Supervisor 2 (900) has been verified. The elements may be implemented in hardware, software or a mixture of hardware and software, within Supervisor 1 (600), although external hardware and/or software could carry out the functions. Messaging within the message redirection module, e.g., within Supervisor 1 (600), may be implemented with communication protocols appropriate to the operating characteristics of the supervisor(s) and other elements of a particular instance of the system.

In the diagram, Edge Routers may represent multiple devices, sensors, and/or data representing current or desired values for states of the environment, for example, a thermostat may report a current temperature and a desirable temperature setpoint. Other data may represent a state such an On/Off switch. Supervisor 1 and Supervisor 2 represent two different headend supervisor software implementations trying to communicate with the Edge Router(s) and with each other on a single endpoint. Thus, the present system may generate or capture data and act upon that data. The data may be of an HVAC system, sensors, occupancy, guest service requests, and so on. The data may reside in the cloud storage as a part of an INNcontrol™ supervisor application. The system may relate to INN control 5™ and INNCOM™ IC5 Supervisor MVO1.

Viewed at a high level, the underlying system, for example, normally collects information from an environment, such as a room among a group of rooms, and periodically sends, or attempts to send, the collected information to and through an edge router that manages network traffic to and from the supervisor software. The edge router forwards the information, including a source identifier, to a software based supervisor, optionally referred to as a coordinating supervisor. The supervisor software evaluates the state of the reporting environment, or parts thereof, and generates a packet directed to the environment if changes are desirable. In addition, the supervisor software provides an updating stream of useful information regarding the current state of the system as a whole, such the current time according to a master system clock, the availability of system resources, e.g. heating capacity and/or cooling capacity, and the status of system wide functions, such as room service, elevators, WiFi, CableTV, and the like. The two streams may be combined and sent back through the edge router to effect any necessary changes in operation within the environment.

When it is desirable to add another supervising software entity to a system outlined above, difficulties related to addressing of packets and the possibility of conflicting commands may arise. However, it is often useful to provide an active backup for the primary supervisor software and or to provide transitional support as a client transitions from one, usually older supervisor software package to a newer software package having updated or at least different capabilities. In view of the differing capabilities, it is desirable to delay the switchover to the new software package until it has been tested in the current operating environment and shown to be functional.

The present system provides a 3-way bidirectional message redirector that addresses the technical challenge of making 3-way bidirectional communication possible for devices and routers that are configured to operate in a communication environment in which they only communicate with single headend software through a single IP endpoint. As shown in exemplary FIG. 1, two edge routers (100, 200) are able to send, for example, User Datagram Protocol (UDP) packets to Port 1 (300) of message redirector module 10 of Supervisor 1 (600).

For the purpose of providing a non-limiting example, consider an edge router (100) which provides communication for local resources, such as a room controller (not shown), in a building having a number of rooms, wherein each room has its own assortment of sensors and actuators. For example, a room may have a thermostat that registers the current temperature in the room and a current temperature setpoint value indicating a desired temperature in the room. Other functional data is contemplated such as the current time according to a master system clock, whether the room is currently occupied, whether doors and windows are open or closed, a current temperature in the room and a current temperature setpoint value indicating a desired temperature in the room, and so forth. In the example, a local room controller assembles a packet of data relating to the state of that room, attaches an appropriate message header to the packet data, and forwards the packet via Edge Router 1 (100) to Port 1 (300) within a supervisor 1 (600) using, for example, the User Datagram Protocol (UDP).

Once a UDP packet is received by Port 1 (300), the packet being tracked is multicast (310, 320) to Buffer 1 (400) that temporarily stores the packet until it is retrieved by Buffer 2 (410) and also to Buffer 3 (500) (to be discussed in more detail later). Port 1 (300) then returns to listening for and receiving message traffic. Buffer 1 (400) makes available received packets, in the order that the packets were received, to Buffer 2 (410), which may reformat the packet if necessary, and then forward the packet data to an internal Port 2 (350) of the message redirector module (10) and from there to a supervisor application running on Supervisor 1 (600), for conventional updating of a database of data points associated with the room, or other sources of information, and selection of desired operational changes, if necessary, before forwarding a return message to Buffer 5 (420) where system wide information is added thereby carrying out a normal operational sequence. The resulting information is transmitted in parallel to two synchronization gates, Sync 1 (810) and Sync 2 (820) of the message redirector unit (10), which resolve any arrival time conflicts, for example, according to time stamps carrying the system master clock time at which the packet was generated, if necessary.

Returning to a second, largely parallel data path introduced earlier, Buffer 3 (500) temporarily stores received packets in sequence until retrieved by Buffer 4 (510) for any necessary protocol translations before reaching the second synchronization gate, Sync 2 (820), which gate determines the sequence in which packets from Buffer 4 (510) and the Buffer 5 (420), discussed earlier, will reach Port 3 (375) for communication to Port 4 (950) of Supervisor 2 (900).

At this point, it should be noted that Buffer 5 (420) may also carrying periodic system data packets relevant to the room whose packet is currently being processed, for example, the time at the system master clock and/or the state, e.g., the availability of chilled water, the availability of steam for heating, and so on, which messages are addressed to the room that sent the packet currently being processed. When such packets are received at Port 3 (900) and passed to Port 4 (950) of Supervisor 2 (900), Supervisor 2 (900) has the information necessary to determine independently what commands, if any, Supervisor 2 (900) would have issued were Supervisor 2 (900) the primary supervisor; however, returning data packets from Buffer 5 (420) addressed specifically to the originating environment will be ignored because their return address is not recognized.

During normal operation, among the commands included in the periodic system data packets issued by Buffer 5 (420), is a command which instructs Supervisor 2 (900) not to issue any packets for a predetermined time period. Thus, Supervisor 2 (900) will not issue commands as long as Supervisor 1 (600) is functioning normally. If, however, for some reason Supervisor 1 (600) fails to issue its “heartbeat” or periodic system data packets through Buffer 5 (420), the inhibition of Supervisor 2 (900) commands is no longer present and Supervisor 2 (900) assumes control of the operation.

When Supervisor 2 (900) is in control, its packets are sent through Port 4 (950) and Port 3 (375) to synchronization gate Sync 1 (810) and thence to Buffer 6 (800) for return to Edge Router 1 (100) via Port 1 (300) to complete a cycle of information exchange.

During the course of normal operation control is assumed by Supervisor 1 (600) as described above and Supervisor 2 (900) monitors and logs the packet traffic while verifying that it would have duplicated the responses of Supervisor 1 (600) and reporting any discrepancies to system users. The system users may then determine if the response offered by Supervisor 2 (900) reflects features of a new supervisor and/or if the response indicates that the programming of Supervisor 2 (900) needs to be changed before Supervisor 2 (900) replaces Supervisor 1 (600).

It should be apparent that verification of the operation of Supervisor 2 (900) may include a system user intervention to pass control to Supervisor 2 (900) for testing intervals by instructing Supervisor 1 (600) to omit “heartbeat” or periodic system data packets. When it is desired to resume normal operation at the end of a testing interval, this may be accomplished by restoring the “heartbeat” or periodic system data packets of Supervisor 1 (600).

In this way, the system itself is configured to detect the presence or absence of elements of the system and to transfer control to and from the appropriate coordinating supervisor without user intervention, while retaining to option for system users to intervene if that function is desired.

It should be understood that this disclosure is, in many respects, only illustrative. Changes may be made in details such as arrangement of components. The disclosure's scope is, of course, defined in the language in which the appended claims are expressed.

What is claimed is:

1. A control system comprising:
a first coordinating supervisor configured to execute conventional database management, data storage and retrieval functions, and to issue user commands;
second coordinating supervisor configured to execute conventional database management functions, data storage and retrieval functions, and to issue system and system user commands;
at least one edge router configured to collect, consolidate, format and transmit data from multiple sensors, devices, located within one or more environments under control of the control system and configured to receive and distribute data and system and user commands to devices within the one or more one environments;
wherein the first coordinating supervisor includes a data redirection module configured to:
(a) receive consolidated data streams from the at least one edge router connected to a first port of the data redirection module; and
(b) replicate the consolidated data streams for distribution along a first data path to be processed by the first coordinating supervisor and for distribution along a second data path to a second coordinating supervisor;
wherein the control system has a first configuration in which the first coordinating supervisor processes a consolidated data stream of the first data path from the at least one edge router according to a first set of operating rules, combines resulting instructions with data relating to a state of the system as a whole and an inhibitory command that prevents the second coordinating supervisor from transmitting for a predetermined time period and sends combined instructions, data, and command to the first port of the control system which forwards the combined instructions, data, and command to the first port for transmission to the at least one edge router and thence to the one or more environments and to a second port attached to the second supervisor to be monitored; and
wherein the control system has a second configuration in which the first coordinating supervisor does not issue the inhibitory command and, following the predetermined time period, the second coordinating supervisor processes the consolidated data stream of the second data path from the at least one edge router according to a second set of operating rules, combines resulting instructions with data relating to the state of the system as a whole and sends the combined instructions and data to the first port, to edge router, and to the one or more environments.

2. The control system of claim 1, wherein the first data path includes one or more data buffers that maintain a sequence of the consolidated data streams and perform any necessary format translations.

3. The control system of claim 1, wherein the second data path includes one or more data buffers that maintain a sequence of the consolidated data streams and perform any necessary format translations.

4. The control system of claim 1, wherein the data redirection module includes one or more synchronization gates that pass an earlier of two overlapping data packets.

5. The control system of claim 1, wherein a system user may disable supervisor 1 thereby transferring the control system from the first configuration to the second configuration.

6. The control system of claim 5, wherein a system user may enable supervisor 1 to resume operation in the first configuration.

7. The control system of claim 1, wherein in the first configuration the second coordinating supervisor processes the consolidated data stream of the second data path from the at least one edge router according to a second set of operating rules to obtain a second set of resulting instructions that are then compared with the resulting instructions produced by the first coordinating supervisor.

8. The control system of claim 7, wherein when instructions obtained by the first coordinating supervisor for a given consolidated data stream differ from instructions obtained by the second coordinating supervisor for a given consolidated data stream, an event is logged and a notification is sent to a system user.

9. The control system of claim 1, wherein when the first coordinating supervisor fails, the control system transitions from the first configuration to the second configuration without operator intervention.

10. The control system of claim 1, wherein data collected, consolidated, formatted and transmitted from within one or more environments includes one or more of a current time indicated by a master system clock, a current temperature in a room, a current temperature setpoint value indicating a desired temperature in the room, an indication of whether a door is open or closed, an indication of whether a window is open or closed, whether the room is occupied or unoccupied, current temperature in the room, and a current temperature setpoint value indicating a desired temperature in the room.

11. The control system of claim 1, wherein data returned to the one or more environments includes one or more of a current time indicated by a master system clock, an availability of chilled water, and an availability of steam for heating.

12. The control system of claim 1, wherein the first set of operating rules and the second set of operating rules are the same.

13. The control system of claim 1, wherein the first set of operating rules and the second set of operating rules are not identically the same.

14. The control system of claim 1, wherein the communication protocol between the one or more edge routers and the first port of the data redirection module is User Datagram Protocol.

15. The control system of claim 1, wherein the communication protocol between the second port of the data redirection module and a port of the second coordinating supervisor is Transmission Control Protocol.
